(19) United States
(12) Patent Application Publication
(10) Pub. No.: US 2004/0096359 A1
(43) Pub. Date: May 20, 2004

(54) Device for connecting capillary columns to a micro-fluidic component

(76) Inventors: Nicolas Sarrut, Seyssinet Pariset (FR); Yves Fouillet, Voreppe (FR); Raymond Charles, Saint Jean de Moirans (FR); Jean-Antoine Gruss, Seyssinet Pariset (FR); Maurice Rostaing, Ville Sous Anjou (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/468,141

(22) PCT Filed: Feb. 27, 2002
(86) PCT No.: PCT/FR02/00710

(30) Foreign Application Priority Data
Mar. 1, 2001 (FR) 01/02803

(51) Int. Cl. G01N 21/00

(52) U.S. Cl. 422/63; 422/100

(57) ABSTRACT

The invention concerns a device (1) for the tight and reversible connection of at least one capillary (13) to a micro-fluidic component (2). The device comprises a rigid part (11) comprising means of positioning the capillary (13) so that it can be connected to the micro-fluidic component (2), means for attaching and positioning the rigid part with respect to the micro-fluidic component, a flexible seal (16) placed between the rigid part (11) and the micro-fluidic component (2) and through which the capillary (13) passes, the flexible seal (16) and the rigid part (11) making the tightness of the connection when the rigid part (11) is pressed by the attachment means onto the micro-fluidic component (2).

### TECHNICAL FIELD

The invention concerns a device for the tight, reversible and advantageously collective connection of capillaries to a micro-fluidic component, in particular a biochip. The invention emerges in particular from the field of medical, pharmaceutical, biological research, etc.

### STATE OF THE PRIOR TECHNIQUE

In many micro-fluidic applications, micro-fluidic components (groups of micro-channels, micro-tanks, micro-reactors, micro-valves heating systems, etc.) need to be connected to one another or to external systems (tanks, injection systems, etc.). One solution that is often used for this connection is to use micro-tubes or capillaries. The latter must be inserted inside a micro-component leading to a hollow structure such as a channel, tank, reactor, etc. The capillaries are generally grouped together in bundles or layers. At the connection with the micro-component, the seal between the capillaries and the outside is made tight by gluing or forced insertion. The article (Novel interconnection and Channel Technologies for Microfluidics” by N. J. MOURLAS et al., Proc. of the Micro Total Analysis Systems '98, Oct. 13-16, 1998, pages 27 to 30, can be consulted on this subject.

The problem that is then posed is that the use of glue means that the connection is not reversible. Once the capillaries have been glued, they become part of the micro-component and cannot be removed to be changed or cleaned for example. In the case of the capillaries being inserted by force, this solution is not compatible with a collective connection of several capillaries and requires an intermediate part whose size means that it cannot be used.

### Presentation of the Invention

The invention permits a solution to be provided to this problem. It consists of fitting a flexible seal to a rigid part close to the end of the capillaries to be connected. The rigid part ensures that the capillaries are in their correct relative positions. By pressing the flexible seal on the micro-component, the seal is compressed and thus prevents leaks (between capillaries and with the outside) and the ends of the capillaries enter the micro-component.

The invention therefore provides the advantage of a reversible connection.

The connection device of the invention adapts to the connection of chips made of plastic, silicon, glass and other materials. They can be connected in their plane or perpendicularly for flat micro-components, and on any face for voluminal micro-components.

The invention therefore concerns a device for the tight reversible connection of at least one capillary to a micro-fluidic component, characterised in that it comprises a rigid part comprising means of positioning the capillary so that it can be connected to the micro-fluidic component, means for attaching and positioning the rigid part with respect to the micro-fluidic component, a flexible seal placed between the rigid part and the micro-fluidic component and through which the capillary passes, the flexible seal and the rigid part making the tightness of the connection when the rigid part is pressed by the attachment means onto the micro-fluidic component, the flexible seal being moulded onto the rigid part and around the capillary.

This embodiment permits, for the dimensions considered, to obtain perfect tightness by creating physical adherence between the flexible seal and the capillaries, and consequently a real barrier to the liquid present at this part of the component.

Advantageously, the capillary positioning means are formed by a hole passing through the rigid part. The capillary may be held onto the rigid part by glue. In the case of a hole passing through the rigid part, the glue is advantageously placed between the hole passing through the rigid part and the capillary in order to ensure that it is held in position on the rigid part. The rigid part may also have a face with a channel allowing glue to be introduced.

The means for attaching and positioning the rigid part with respect to the micro-fluidic component may be screwing means. These screwing means may comprise screws which are inserted into the micro-fluidic component, and can be screwed either into nuts or a threaded hole on the micro-fluidic component. If the component is held by a support, the screwing means may comprise screws which enter into the support, and screwed either into nuts or a threaded hole on the support.

The rigid part may be made of plastic or metal.

### BRIEF DESCRIPTION OF THE DRAWINGS

The invention will be easier to understand and other advantages and specific features will become clearer after reading the following description, given by way of non-restrictive example and accompanied by appended drawings, including:

FIG. 1 is an exploded view associating a micro-fluidic component, partially represented, and a device for tight connection of the capillaries of the invention,

FIG. 2 is a partial perspective view of a micro-fluidic component held in a support and capable of being connected perpendicularly to its plane by the connection device of the invention,

FIG. 3 is a partial perspective view of a micro-fluidic component held in a support and capable of being connected frontally by the connection device of the invention.

### DETAILED DESCRIPTION OF EMBODIMENTS OF THE INVENTION

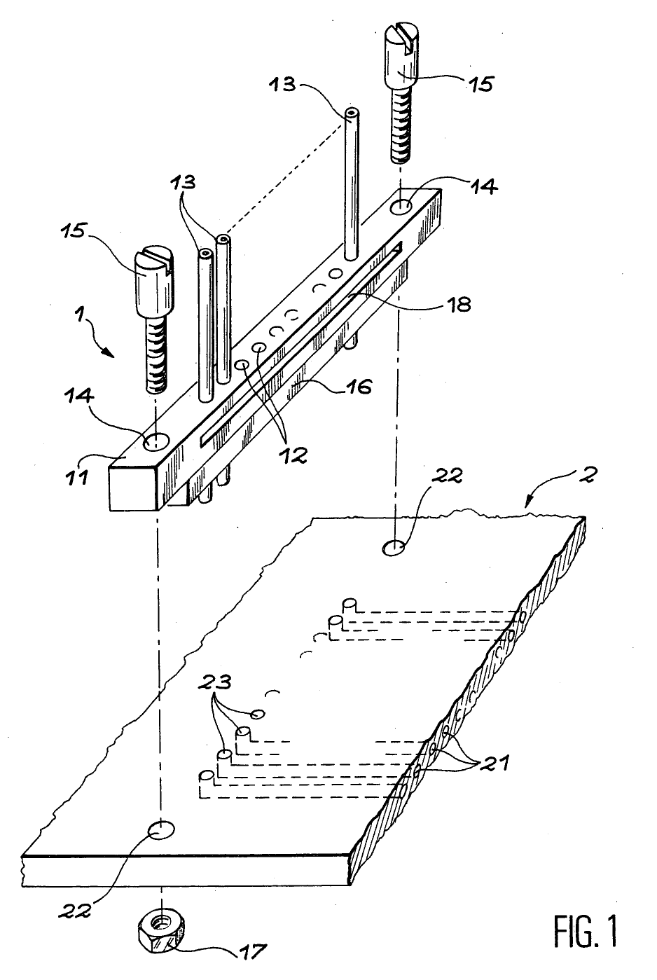

In FIG. 1, the reference 1 represents the tight connection device of the invention and reference 2 represents a micro-fluidic component to be connected perpendicularly to its plane.

The tight connection device 1 comprises a rigid part 11 which can be made of plastic (e.g. polycarbonate) or metal (e.g. brass). It may be obtained by machining or by moulding. It comprises holes 12 which pass through it designed for the passage of the capillaries 13 to align them and hold them in position. These through holes 12 are advantageously countersunk on the side where the capillaries are inserted to make it easier to position them, especially for industrialised and automated production of the connection devices. It also has through holes 14 designed for the passage of the screw rods 15.

The capillaries 13 are for example cast silicon micro-tubes sheathed with polyamide. Their internal diameter is between 2 and 500 μm and their external diameter is between 50 and 700 μm.

The pitch of the holes 12, which determines the pitch of the capillaries, is equal to the pitch between the channels 21 of the component 2. Depending on the capillaries, it may be between a tenth and a hundredth of a μm.

The capillaries 13 are inserted into the holes 12 to a depth suited to the component to be connected. They are attached to the rigid part 11 by glue. The type of glue used depends on the material that the rigid part is made from. Several different types of glue on sale may be used.

According to one embodiment, the rigid part 11 has a channel 18 on one of its main faces parallel to the plane of the capillaries. This channel 18 provides perpendicular access to a portion of the capillaries. The glue is poured into this channel and the capillaries are thus attached to the rigid part at the bottom of this channel.

The face of the rigid part 11 which faces the component 2 when connected is fitted with a flexible seal 16. The flexible seal 16 is obtained by attaching a parallelepiped shaped mould to the corresponding face of the rigid part 11, the capillaries 13 being already attached to the rigid part, and by pouring the seal in liquid form. By way of example, the material used to make the seal can be RTV-2 silicone manufactured by Rhone-Poulenc. The flexible seal holds the capillaries 13 and ends before the holes 14 that the screws 15 pass through.

When the material forming the seal is poured in liquid form, it comes into perfect contact with the capillaries due to the properties of the liquids. When the material hardens (by polymerisation for silicone), it keeps this favourable property and the contact between the flexible seal and the capillaries remains perfect. Furthermore, and again thanks to the properties of the liquids, when the material which forms the seal is poured in liquid form, it runs along the capillaries slightly and forms a bead at the foot of the zone leaving the capillary. Once compressed, this bead (which is an excess of material) exerts a strong pressure on the walls of the access holes of the micro-fluidic component and on the capillaries. In this way, complete and perfect tightness is obtained: tightness with respect to the outside (no leaks along the capillary) and tightness from one hollow structure to another (no leaks on the flexible seal).

The screws 15 have for example a knurled head. Their rod is sufficiently long to pass through the rigid part 11 equipped with the flexible seal 16 and the thickness of the component 2. At the connection, the screw rods 15 pass through the holes 22 to be fitted with nuts 17 on the other side of the component 2. When they are tightened, the heads of the screws press the rigid part against the component with the flexible seal between them, which is consequently compressed to ensure the tightness. The tightness of the devices thus formed remains intact during pressure tests carried out at 3 bars.

At the connection, the ends of the capillaries 13 may be inserted into the orifices 23 which provide access to the inside of the micro-component, for example to the angled parts of the channels 21 or to other hollow structures.

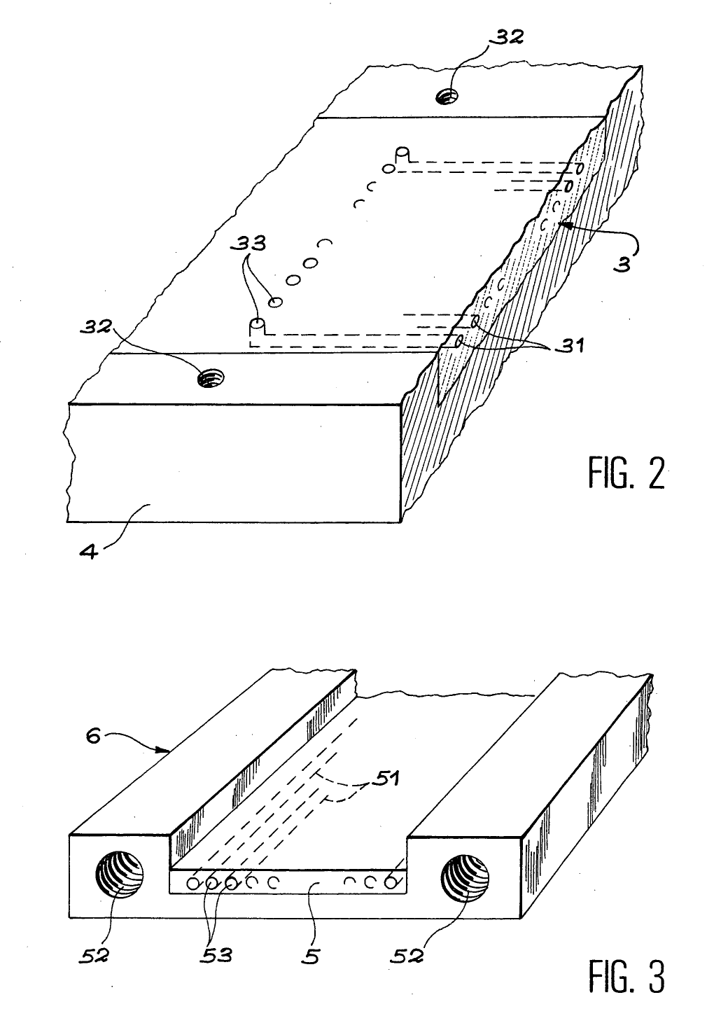

FIG. 2 is a partial perspective view of a micro-fluidic component 3 held in a support 4. The support 4 may be made of plastic or metal. It is either glued or interlocked with the component 3. As previously described, the connection is made perpendicularly to the plane of the component 3, the ends of the capillaries are inserted into the orifices 33 which provide access for example to the angled parts of the channels 31.

In this embodiment, the connection device is attached to the support 4 which has holes 32 to accommodate the attachment screws. The holes 32 may be passage holes for the threaded rods of the screws, in which case the connection device is clamped by the nuts which press against the rear face of the support. The holes 32 may, in one embodiment, be threaded, which avoids the use of nuts on the rear face of the support. This embodiment provides a gain in space on the component as the attachment holes are made in the support.

FIG. 3 is a partial perspective view of another micro-fluidic component, 5, held in a support 6. As previously described, the support may be made of plastic or metal and can be either glued or interlocked with the component. The difference with the previous embodiment is that the orifices 53 of the channels 51 are located on the front face of the component. In this case, the connection is made in the plane of the component.

The support 6 has holes 52 to house the attachment screws. The holes 52 may be passage holes for the threaded rods of the screws, in which case the connection device is clamped by the nuts which press against the opposite face of the support 6. The holes 52 may, in one embodiment, be threaded, which avoids the use of nuts. This embodiment provides a gain in space on the component as the attachment holes are made in the support.

The connection device of the invention may be used for any micro-fluidic component. The main applications which use this type of component are chemical, biological, pharmaceutical, medical, (dosing micro-volumes, chemical reactions on micro-volumes, genotyping, diagnosis: DNA chips, etc.).

1. Device (1) for the tight and reversible connection of at least one capillary (13) to a micro-fluidic component (2), characterised in that it comprises a rigid part (11) comprising means of positioning the capillary (13) so that it can be connected to the micro-fluidic component (2), means for attaching and positioning the rigid part with respect to the micro-fluidic component, a flexible seal (16) placed between the rigid part (11) and the micro-fluidic component (2) and through which the capillary (13) passes, the flexible seal (16) and the rigid part (11) making the tightness of the connection when the rigid part (11) is pressed by the attachment means onto the micro-fluidic component (2), the flexible seal being an element which is moulded onto the rigid part (11) and around the capillary (13).

2. Device of claim 1 characterised in that the means for positioning the capillary (13) are composed of a hole which passes through the rigid part (12).

3. Device of any of claims 1 or 2 characterised in that the capillary (13) is glued onto the rigid part (11).

4. Device of claims 2 and 3 together, characterised in that the glue is positioned between the through hole (12) of the rigid part (11) and the capillary (13) in order to ensure that it is held on position in the rigid part.

5. Device of claims 2 and 3 together, characterised in that the rigid part (11) has one face with a channel (18) in it allowing said glue to be inserted.

6. Device of any of claims 1 to 5, characterised in that the means for attaching and positioning the rigid part with respect to the micro-fluidic component are screwing means (15, 17).

7. Device of claim 6, characterised in that the screwing means comprise screws (15) which are inserted into the micro-fluidic component (2), and are either screwed into nuts (17) or a threaded hole in the micro-fluidic component.

8. Device of claim 6, characterised in that as the component (3, 5) is held by a support (4, 6), the screwing means comprise screws which are inserted into the support, and so the screws are either screwed into nuts or a threaded hole in the support.

9. Device of any of the previous claims, characterised in that the rigid part (11) is made of plastic or metal.
